(19) United States
(12) Patent Application Publication
(10) Pub. No.: US 2008/0002540 A1
(43) Pub. Date: Jan. 3, 2008

(54) Holographic diffraction element and optical pickup device using holographic diffraction element

(76) Inventors: Takehiro Hiramatsu, Yokohama-shi (JP); Nobuaki Kaji, Yokohama-shi (JP); Sumitaka Maruyama, Kyoto-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/824,026

(22) Filed: Jun. 29, 2007

(30) Foreign Application Priority Data
Jun. 30, 2006 (JP) 2006-182660

(51) Int. Cl. G11B 7/00

(52) U.S. Cl. 369/44.37; 369/44.23

(57) ABSTRACT

According to one embodiment, a holographic diffraction element is divided into a plurality of regions which diffract reflected light from an optical recording medium to a plurality of photodetectors. Diffracted light for detecting a focus error signal and a compensation signal for a tracking error signal is obtained from one or more common regions of the plurality of regions.

### CROSS-REFERENCE TO RELATED APPLICATIONS

This application is based upon and claims the benefit of priority from Japanese Patent Application No. 2006-182660, filed Jun. 30, 2006, the entire contents of which are incorporated herein by reference.

### BACKGROUND

1. Field

One embodiment of the invention relates to a holographic diffraction element and an optical pickup device using a holographic diffraction element.

2. Description of the Related Art

Optical discs are widely used as recording media suitable for recording, reproducing, and erasing (at the time of repetitive recording) of information. Actually, various specifications (kinds) of optical discs have been proposed and put into practical use. From a perspective of recording capacity, these optical discs can be classified into optical discs according to the CD specification and optical discs according to the DVD specification. In addition, from a perspective of application (data recording format), optical discs can be classified into three types as follows. A first type of optical disc is a playback-only optical disc on which information is permanently recorded. Optical discs of the first type include, for example, CD-ROMs and DVD-ROMs. A second type of optical disc is a write-once optical disc which allows recording of information only once. Optical discs of the second type include, for example, CD-Rs and DVD-Rs. A third type of optical disc is a rewritable optical disc which allows repetitive recording and erasing. Optical discs of the third type include, for example, CD-RWs and DVD-RAMs.

With diversification of specifications and applications of optical discs as mentioned above, it is desired for an optical disc recording/reproducing apparatus to be able to record information on optical discs according to two or more specifications, reproduce information recorded on these optical discs, or erase information already recorded on these optical discs. Even if it is difficult for the optical disc recording/reproducing apparatus to record information on and erase information from optical discs according to two or more specifications, it is required for the optical disc recording/reproducing apparatus to identify the specification of an optical disc which is inserted therein.

Hence, an optical pickup device incorporated in the optical disc recording/reproducing apparatus should be able to obtain a reflected light from a track or a recording mark sequence peculiar to optical discs, and to perform tracking control and focus control of an objective lens (optical pickup device).

Various methods have been proposed for tracking control and focus control. An example of such methods is a method of using a diffraction element (holographic element) in an optical pickup device. For example, Japanese Patent Application KOKAI Publication No. 2-187936 describes a technique of using a diffraction element which is divided into two regions. A diffracted light from each of the two regions of the diffraction element is received by a corresponding photo-receiving element which is divided into two regions. A common region is used for detecting a focus error signal (called a focus region) and for detecting a tracking error signal (called a tracking region). In the signal from the common region includes a track cross component. Thus, the focus error signal also includes a track cross component and it is difficult to stably perform a focus servo.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic diagram showing an exemplary configuration of an optical disc recording/reproducing apparatus including a holographic diffraction element according to one embodiment of the invention;

FIG. 2A is an exemplary schematic diagram of the holographic diffraction element according to the embodiment of the invention;

FIG. 2B is an exemplary schematic diagram showing photodetectors which receive light diffracted by the holographic diffraction element 14 shown in FIG. 2A;

FIG. 3 is an exemplary schematic diagram for explaining reflected light from a reproducing layer and reflected light from a non-reproducing layer in the case where a dual layer disc is reproduced;

FIG. 4 is an exemplary schematic diagram for explaining a dividing pattern of the holographic diffraction element according to the embodiment of the invention;

FIG. 5 is a graph showing the signal intensity of a DPD (Differential Phase Detection) signal in a system lead-in area;

FIG. 6A is an exemplary schematic diagram showing an exemplary arrangement pattern of receiving regions of photodetectors;

FIG. 6B is an exemplary schematic diagram showing another exemplary arrangement pattern of receiving regions of photodetectors; and

FIG. 6C is an exemplary schematic diagram showing still another exemplary arrangement pattern of receiving regions of photodetectors.

### DETAILED DESCRIPTION

Various embodiments according to the invention will be described hereinafter with reference to the accompanying drawings. In general, according to one embodiment of the invention, a holographic diffraction element divided into regions which diffract reflected light from an optical recording medium to photodetectors, wherein diffracted light for detecting a focus error signal and a compensation signal for a tracking error signal is obtained from one or more common regions of the regions.

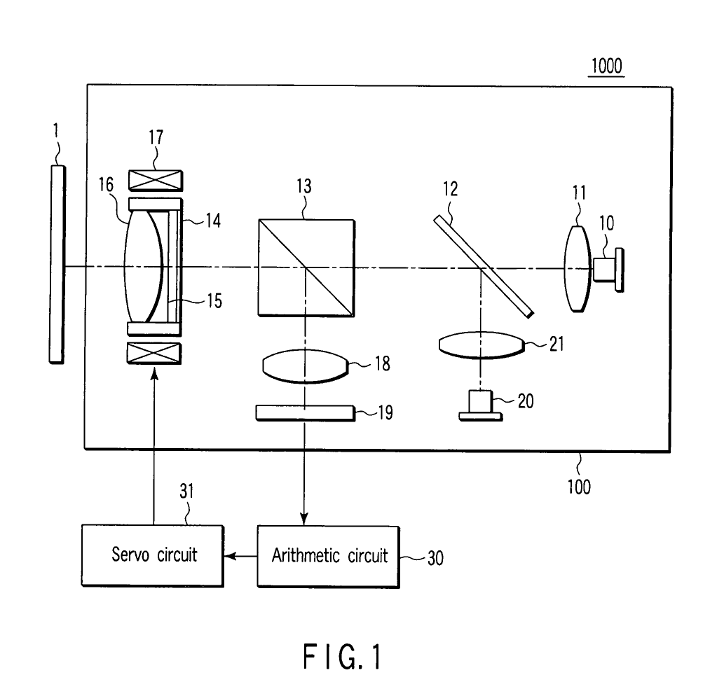

FIG. 1 is an exemplary schematic diagram showing a schematic structure of an optical disc recording/reproducing apparatus (hereinafter referred to as “optical disc apparatus”) 1000 which includes a holographic diffraction element 14 according to one embodiment of the invention. FIG. 1 shows a state where an optical disc 1 is inserted into the optical disc apparatus 1000.

The optical disc 1 may be an optical disc according to a new specification such as an “HD DVD” (also referred to as “the next-generation DVD”, and hereinafter referred to as “HD DVD”). Compared to an optical disc according to the current DVD specification, an HD DVD allows recording with a higher density. It should be noted that the optical disc 1 is not limited to the HD DVD. The optical disc 1 may be any one of a CD-ROM, a DVD-RAM, a DVD-RW, and other various kinds (specifications) of known optical discs.

A description is given of an exemplary schematic structure of the optical apparatus 1000 and each component forming the optical disc apparatus 1000.

The optical disc apparatus 1000 shown in FIG. 1 includes an optical pickup device (pickup head actuator) 100, an arithmetic circuit (signal processing unit) 30, and a servo circuit (lens position controlling device) 31. The optical disc apparatus 1000 can record information on or reproduce information from the optical disc 1 by focusing a laser light emitted from the optical pickup device 100 onto a recording medium, i.e., an information recording layer of the optical disc 1. In the optical disc apparatus 1000, the optical disc 1 is supported by a turntable (not shown) of a disc motor (not shown). The optical disc 1 is rotated at a predetermined speed by rotating the disc motor at a predetermined speed of rotation.

The optical pickup device 100 is moved by a pickup motor (not shown) in radial directions of the optical disc 1 at a predetermined speed at the time of each operation of recording, reproducing, or erasing of information.

The optical pickup device 100 includes a first semiconductor laser element 10, a first collimating lens 11, a dichroic mirror 12, a polarized beam splitter 13, the holographic diffraction element 14, a λ/4 board (¼ wave plate) 15, an objective lens 16, a focusing/tracking coil 17, an imaging lens 18, a photo detector (PD) 19, a second semiconductor laser element 20, and a second collimating lens 21.

The first semiconductor laser element 10 emits an optical beam (laser beam) having a first wavelength. The first collimating lens 11 collimates the optical beam emitted from the first semiconductor laser element 10. The second collimating lens 21 collimates an optical beam emitted from the second semiconductor laser element 20. The first semiconductor laser element 10 and the second semiconductor laser element 20 are arranged such that the directions of main beams of the first semiconductor laser element 10 and that of the second semiconductor laser element 20 cross at an approximately right angle. The optical path of the laser light (optical beam) emitted from the first semiconductor laser element 10 and that emitted from the second semiconductor laser element 20 are superimposed by the dichroic mirror 12, such that the optical axis (the direction of the main beam) of the laser light toward the objective lens 16 from the first semiconductor laser element 10 becomes generally identical to that from the second semiconductor laser element 20.

The polarized beam splitter 13 is provided between the holographic diffraction element 14 and the photo detector 19. The polarized beam splitter 13 transmits the optical beams from the first semiconductor laser element 10 and the second semiconductor laser element 20 toward the optical disc 1 (the objective lens 16). Additionally, the polarized beam splitter 13 reflects the laser light reflected by a recording surface of the optical disc 1 toward a receiving surface of the photo detector 19.

The λ/4 board 15 is provided between the objective lens 16 and the photo detector 19. The λ/4 board 15 changes the direction of a plane of polarization of the laser light reflected by the recording surface of the optical disc 1 by 90 degrees with respect to the direction of a plane of polarization of the laser light guided to the recording surface of the optical disc 1 from the first semiconductor laser element 10 and the second semiconductor laser element 20. As shown in FIG. 1, the λ/4 board 15 may be integral with the objective lens 16 and the focusing/tracking coil 17. In addition, the holographic diffraction element (wavefront splitting element, holographic optical element) 14, which provides predetermined characteristics to a wavefront of the laser light reflected by the optical disc 1, is integrally formed on a side (i.e., the side through which enters the optical beams from the first semiconductor laser element 10 and the second semiconductor laser element 20) of the λ/4 board 15 which side is opposite to the objective lens 16. The characteristics provided by the holographic diffraction element 14 to the reflected laser light include: diffraction in a plurality of directions; and splitting of a wavefront into a plurality of portions.

The objective lens 16 is arbitrarily moved by the focusing/tracking coil 17 in each of (1) a focusing direction, i.e., a direction orthogonal to a surface including the recording surface of the optical disc 1, and (2) a tracking direction, i.e., a direction which is parallel to the surface including the recording surface of the optical disc 1 and is a radial direction of the optical disc 1. The objective lens 16 may be made of, for example, plastic. Additionally, the numerical aperture NA of the objective lens 16 may be, for example, 0.65.

The photo detector 19 receives the laser light reflected by the recording surface of the optical disc 1 and captured by the objective lens 16, and outputs a signal (or, a current or a voltage) corresponding to the intensity of the laser light. The photo detector 19 is located at a position where the spot diameters on the recording surface of the optical disc 1 of the optical beams having first and second wavelengths from the first and second semiconductor laser elements 10 and 20, respectively, become the minimum. That is, the photo detector 19 is located at a position where an optical spot having a predetermined size (cross-section area) is obtained on the photo detector 19 in an on-focus state. In other words, the photo detector 19 is located at a position where the on-focus state can be determined.

The signal output from the photo detector 19 is processed by the arithmetic circuit 30 into a usable form as a data signal which is used for reproduction of information recorded on the optical disc 1. In addition, a part of the signal output from the arithmetic circuit 30 is supplied to the servo circuit 31. The supplied signal can be used as a control signal for moving the objective lens 16 to a predetermined position with respect to the recording surface of the optical disc 1. That is, the servo circuit 31 supplies a focusing control signal and a tracking control signal to the focusing/tracking coil 17. The focusing control signal is a control signal for moving the objective lens 16 in the above-mentioned focusing direction such that the diameter of the optical spot focused on the recording surface of the optical disc 1 becomes the minimum on the recording layer of the recording surface of the optical disc 1. The tracking control signal is a control signal for moving the objective lens 16 in the above-mentioned tracking direction such that the center of the optical spot corresponds to the center of a track (guide groove) formed in advance or a recording mark sequence recorded in the optical disc 1.

The imaging lens 18 is provided between the polarized beam splitter 13 and the photo detector 19. The imaging lens 18 focuses the laser light reflected by the polarized beam splitter 13 onto the receiving surface of the photo detector 19.

Next, a description is given of an operation of the optical disc apparatus 1000 and each component thereof.

The first semiconductor laser element 10 is positioned, for example, such that an emitted light (laser light) passes through a wavelength selection film (selective reflection surface) of the dichroic mirror 12. Thus, the second semiconductor laser element 20 is positioned, for example, such that an emitted light is reflected by the wavelength selection film of the dichroic mirror 12 and is superimposed on the optical axis of the light directed to the objective lens 16 from the first semiconductor laser element 10. The wavelength of the laser light emitted from the first semiconductor laser element 10 is approximately 405 nm (400-410 nm). The wavelength of the laser light emitted from the second semiconductor laser element 20 is approximately 650 nm (640-670 nm). However, the wavelength of the laser light is not limited to the above-mentioned values. For example, the wavelength of the laser light emitted from the first semiconductor laser element 10 may be approximately 405 nm (400-410 nm), and the wavelength of the laser light emitted from the second semiconductor laser element 20 may be approximately 780 nm (770-790 nm). Further, the wavelength of the laser light emitted from the first semiconductor laser element 10 may be approximately 650 nm (640-670 nm), and the wavelength of the laser light emitted from the second semiconductor laser element 20 may be approximately 780 nm (770-790 nm).

The linear polarized laser light (having a wavelength of, e.g., 405 nm) from the first semiconductor laser element 10 is collimated to parallel light by the first collimating lens 11, passes through the dichroic mirror 12 and the polarized beam splitter 13, then enters the holographic diffraction element 14. The holographic diffraction element 14 can be formed by, e.g., anisotropic optical crystal. The holographic diffraction element 14 produces diffracted light with respect to linear polarized light in a certain direction, but does not produces diffracted light with respect to linear polarized light whose polarizing direction is rotated by 90 degrees.

The polarizing direction of the light which is emitted from the first semiconductor laser element 10 and enters the holographic diffraction element 14 is a direction which does not cause the holographic diffraction element 14 to produce diffracted light. Such light passes through the holographic diffraction element 14 without being diffracted, and enters the λ/4 board 15.

The linear polarized laser light (having a wavelength of, e.g., 405 nm) which enters the λ/4 board 15 is converted into circularly-polarized light, and is focused onto the recording layer of the optical disc by the objective lens 16.

The laser light (having a wavelength of, e.g., 405 nm) reflected by the recording layer of the optical disc 1 is collimated by the objective lens 16. The collimated laser light passes through the λ/4 board 15, and linear polarized light is produces whose polarizing direction is tilted (rotated) by 90 degrees with respect to the polarizing direction of the laser light from the first semiconductor laser element 10 to the optical disc 1. Then, the laser light passes through the holographic diffraction element 14 and is returned to the polarized beam splitter 13.

The laser light (having a wavelength of, e.g., 405 nm) returned to the polarized beam splitter 13 is reflected by the polarized beam splitter 13, and is focused onto the receiving surface of the photo detector 19. It is assumed that the photo detector 19 is divided into a predetermined number of receiving regions (detecting regions, receiving surfaces).

The linear polarized laser light (having a wavelength of, e.g., 650 nm) from the second semiconductor laser element 20 is collimated by the second collimating lens 21. The collimated laser light is reflected by a mirror surface of the dichroic mirror 12, and guided to the polarized beam splitter 13. The laser light passes through the polarized beam splitter 13, and then enters the holographic diffraction element 14. The direction of the plane of polarization of the laser light having the second wavelength and entering the holographic diffraction element 14 is defined in a manner similar to that of the laser light having the first wavelength. The laser light having the second wavelength passes through the holographic diffraction element 14 and enters the λ/4 board 15.

The linear polarized laser light (having a wavelength of, e.g., 650 nm) which enters the λ/4 board 15 is converted into circularly-polarized light, and is focused onto the recording layer of the optical disc 1 by the objective lens 16.

The laser light (having a wavelength of, e.g., 650 nm) reflected by the recording layer of the optical disc 1 is collimated by the objective lens 16. The collimated laser light passes through the λ/4 board 15 again, and linear polarized light is produced whose polarizing direction is tilted (rotated) by 90 degrees with respect to the polarizing direction of the laser light from the second semiconductor laser element 20 to the optical disc 1. Then, the laser light passes through the holographic diffraction element 14 and is returned to the polarized beam splitter 13.

The laser light (having a wavelength of, e.g., 650 nm) returned to the polarized beam splitter 13 is reflected by the polarized beam splitter 13 and is focused onto the receiving regions of the photo detector 19.

The holographic diffraction element 14 has predetermined diffraction characteristics to the laser light such that the diffracted laser beams can reach each of the receiving regions in accordance with the number of the receiving regions of the photo detector 19 and the positions of the receiving regions. In other words, the reflected laser light is divided into a plurality of laser beams by the holographic diffraction element 14. Each of the divided laser beams is provided with predetermined diffraction characteristics. The laser beams having the predetermined diffraction characteristics are focused by the imaging lens 18 onto the respective receiving regions of the photo detector 19. The receiving regions, each having a predetermined size, are provided in a predetermined arrangement.

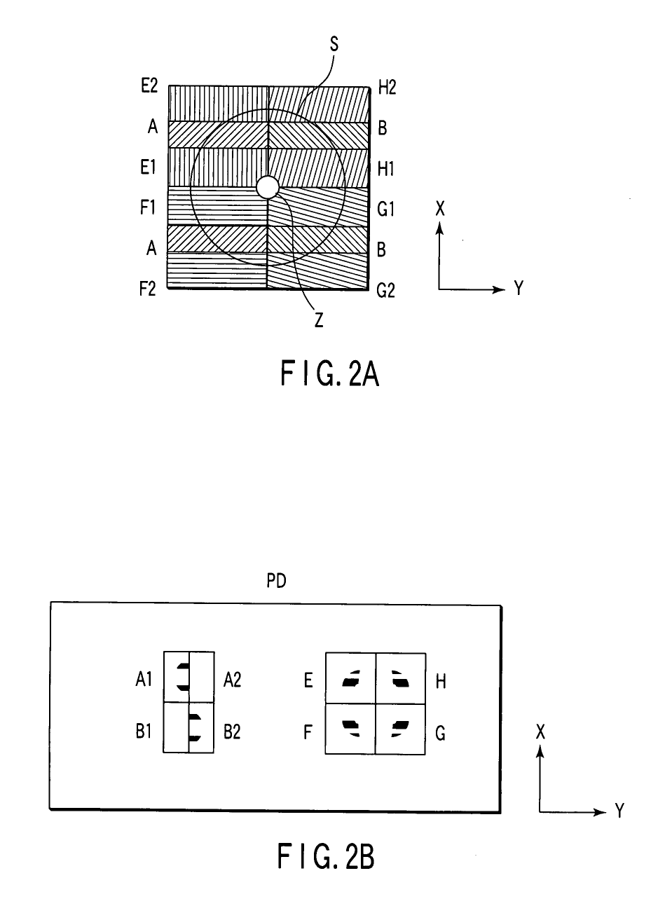

Referring to FIGS. 2A and 2B, a more detailed description is given of the holographic diffraction element 14 and photo detector 19. FIG. 2A is a schematic diagram of a holographic diffraction element according to one embodiment of the invention. FIG. 2B shows a photo detector which receives light diffracted by the holographic diffraction element. In FIGS. 2A and 2B, the direction indicated by an arrow X represents a tangential direction of a track of an optical recording medium, and the direction indicated by an arrow Y represents a radial direction of the optical recording medium. Hereinafter, for convenience of explanation, it is assumed that the holographic diffraction element shown in FIG. 2A is applied to the holographic diffraction element 14 shown in FIG. 1, and the photo detector shown in FIG. 2B is applied to the photo detector 19 shown in FIG. 1.

As shown in FIG. 2A, the holographic diffraction element 14 is divided into a plurality of regions (A, B, E1, E2, F1, F2, G1, G2, H1 and H2), each of the regions having a different grating pitch and grating angle so as to realize different diffraction characteristics. By using the holographic diffraction element 14 divided into plurality of regions in such a manner, the margin for displacement of the photo detector 19 is increased, and the number of optical elements to be used in the optical pickup apparatus 100 can be reduced. Hence, it is possible to, for example, simplify assembling/adjusting processes of the optical disc apparatus 1000 or the optical pickup apparatus 100. In the case where a diffraction element is not used, normally, light is not focused on a receiving element (if the light is focused, only a signal is obtained which is produced by adding all reflected light beams from the disc). On this occasion, when the objective lens is shifted in a radial direction (when there is a lens shift), since the light is not focused, the position of the light is varied. On the other hand, in the case where the diffraction element is used, by mounting the diffraction element on the actuator, the focus position of the light is not varied even if the lens is shifted (only the intensity of the focused light is varied). Hence, when the diffraction element is used, the margin for displacement of the receiving element (photo detector 19) is more increased with respect to the lens shift. Various patterns may be used for the dividing pattern of the holographic diffraction element 14. The dividing pattern of the holographic diffraction element 14 determines the amount of light to be allocated for servo signals, such as a focus error signal and a tracking error signal, and the characteristics of the servo signals.

When a disc is rotated, the light spot crosses the guide groove or the recording mark sequence of the disk if the disk is eccentric. Therefore, a relative phase difference between a zero order diffraction beam which is not diffracted by the guide groove or the recording mark sequence and a first order diffraction beam which is diffracted by the guide groove or the recording mark sequence changes. As a result, the intensity of light changes at an interference region of the zero order diffraction beam and the first order diffraction beam. The change in the intensity of light corresponds to the track cross component. A lens shift component is added to the track cross component.

The lens shift component will be described hereinafter. At the time of reproduction, a servo control including a focus control and a tracking control is performed to control a position of the objective lens or the like of the optical pickup. A center of the track or the guide groove varies in the radial direction of the disk due to an eccentricity of the disk. Therefore, the objective lens shifts in the radial direction of the disk if the tracking control is performed. When a disk having a groove such as DVD-R or HD DVD-R is reproduced, a center of the light intensity shifts from the center of the objective lens. As a result, a tracking error signal (a push-pull signal in the case of a grooved disk) which is a difference between a signal from an inner region of the holographic diffraction element 14 and a signal from an outer region of the holographic diffraction element 14 includes an offset component which is due to a light intensity difference of the laser light but irrespective of the track cross. The offset component is called a lens shift component. Normally, after correcting an electronic offset and a signal offset due to a shift in an optical adjustment, a servo control is performed to make the tracking error signal zero. If the tracking control is performed based on a signal having an offset, a servo control is performed at a position shifted from the center of the groove or the recording mark sequence and the light spot is focused at the irradiated at the position shifted from the center of the groove or the recording mark sequence. A quality of the servo signal and the reproduction signal is deteriorated. If an amount of the lens shift is large, the tracking control cannot be performed and it is difficult to stably perform the servo control.

After the focus control is performed, a signal from a region without a track cross component is only a lens shift component. The region without the track cross component is set to a region for obtaining a compensation signal and thus is called a compensation region. If the compensation signal is subtracted from the tracking error signal, i.e., the lens shift component is subtracted from the tracking error signal, the tracking error signal becomes only the track cross component. Therefore, it is possible to obtain a tracking error signal which does not depend on lens shift. A process for obtaining such a tracking error signal is called a compensated push-pull process.

When determining the dividing pattern of the holographic diffraction element 14, several aspects are considered. As mentioned above, in a conventional method (e.g., Japanese Patent Application KOKAI Publication No. 2-187936), a noise component in a compensation region (region for obtaining a compensation signal) of a diffraction element is also amplified, and the S/N ratio of a compensation push-pull signal, which is a signal obtained by subtracting the compensation signal from a tracking error signal, is lowered. Thus, the compensation region is increased so as to secure a large amount of light for the compensation signal. However, when the compensation region is increased, the focus region and the tracking region are relatively decreased. Hence, it is difficult to increase the compensation region.

In the holographic diffraction element shown in FIG. 2A, common regions (A, B) are used as both of the focus region and the compensation region. That is, diffracted light for detecting the focus error signal and the compensation signal for the tracking error signal is obtained in common from one or more of the regions. More specifically, the focus error signal and the compensation signal for the tracking error signal are detected by a plurality of photo detectors which receive the diffracted light from the common regions of the holographic diffraction element. As a result, it is possible to increase the amount of light in the compensation region without reducing the focus region.

In the single knife edge method, when a receiving element is shifted (displaced) in a direction perpendicular to a dividing line, the area of an optical spot of one side of receiving regions becomes large, and the intensity of a signal is increased. However, the intensity of a signal obtained from the other side of the receiving regions is decreased. Accordingly, the focus error signal may become asymmetric. In the double knife edge method, signals from diagonal receiving regions are added to each other in four receiving regions for focusing. Hence, a large signal and a small signal are added together, which cancels uneven intensities of the signals caused by displacement of the receiving element. Accordingly, the double knife edge method may be used.

Generally, in the case where focus error detection is performed by using the single knife edge method, a diffraction element is divided in a tangential direction of the track. However, in the invention, the double knife edge method is used, and the regions (A, B) obtained by dividing the holographic diffraction element 14 in the radial direction Y are used as the focus regions. Here, dividing a diffraction element indicates that optical beams from the regions are directed to different photo detectors (receiving regions). Even if there are different regions in a diffraction element, in the case where optical beams from these regions are directed to the same photo detector (receiving region), these regions are not considered as divided regions.

Here, a description is given of the tracking error signal (compensation push-pull signal). A push-pull signal can be obtained by the following equation.
Push-Pull Signal=(E+F)−(G+H)

where E=E1+E2, F=F1+F2, G=G1+G2, and H=H1+H2

In addition, a compensation signal can be obtained by dividing the holographic diffraction element 14 in the radial direction Y, and calculating the difference between the amount of light in the inner side of the holographic diffraction element 14 (indicated by A in FIG. 2A, and A1+A2 in FIG. 2B) and the amount of light in the outer side of the holographic diffraction element 14 (indicated by B in FIG. 2A, and B1+B2 in FIG. 2B). The compensation signal can be obtained by the following equation.
Compensation Signal=(A1+A2)−(B1+B2)

Accordingly, the compensation push-pull signal can be represented by the following equation, where “k” represents an appropriate number.
Compensation Push-Pull Signal=(E+F)−(G+H)−k{(A1+A2)−(B1+B2)}

where E=E1+E2, F=F1+F2, G=G1+G2, and H=H1+H2

Additionally, advantages of using a common region for the focus region and the compensation region in the holographic diffraction element 14 include that the number of receiving regions is reduced compared to a conventional method. Conventionally, in the case where the double knife edge method is used for focus error detection, and the differential phase detection (DPD) method is used for tracking error detection in a read-only disc and the compensation push-pull method is used for tracking error detection in a recordable disc, four receiving regions are used for focus error detection, two receiving regions are used for compensation, and four receiving regions are used for tracking error detection (the DPD method and the compensation push-pull method). That is, a total of ten receiving regions are used. On the other hand, in the embodiment of the invention, four receiving regions are used for focus error detection and compensation, and four receiving regions are used for tracking error detection (the DPD method and the compensation push-pull method). That is, only a total of eight receiving regions are used. There are various advantages when the less number of receiving regions are used. For example, the S/N ratio of a receiving element is improved. Additionally, since the chip area of a receiving element becomes small, the cost is reduced. Further, in the case where the number of receiving regions is small, it becomes easy to avoid interlayer crosstalk from non-reproducing layer at the time of reproduction of a dual layer disc.

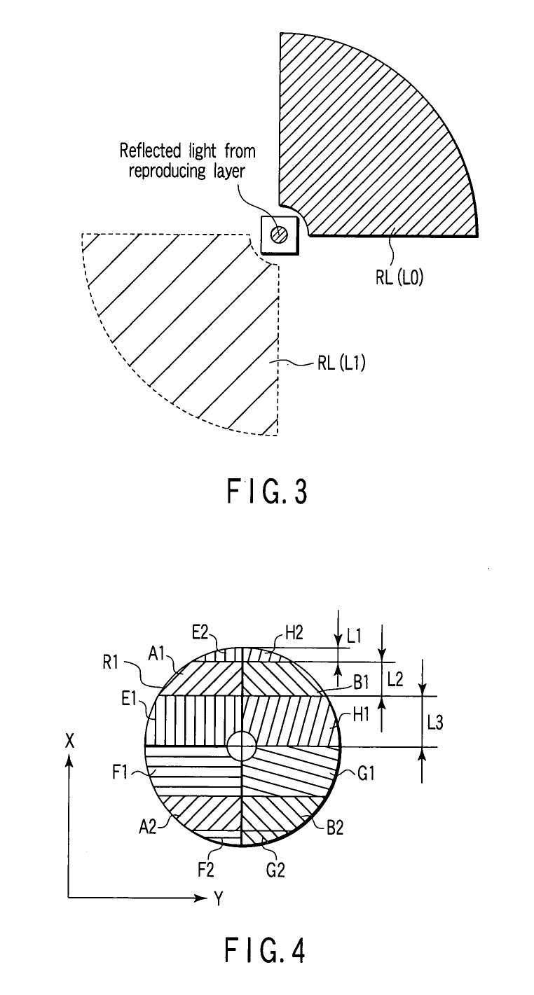

Referring to FIG. 3, a more detailed description is given of a case where a dual layer disc is reproduced. It is to be noted that the holographic diffraction element 14 is divided into a plurality of regions, each of the regions having a different grating pitch and grating angle so as to form the reflected light pattern as shown in FIG. 3. FIG. 3 is a schematic diagram for explaining reflected light from a reproducing layer and reflected light from a non-reproducing layer in the case where the dual layer disc is reproduced. It should be noted that a portion receiving the reflected light from the reproducing layer in FIG. 3A corresponds to a portion indicated by a symbol S in FIG. 2A.

When reproducing the dual layer disc, in addition to the reflected light from the reproducing layer, the reflected light from the non-reproducing layer enters the photo detector. On this occasion, since the reflected light from the non-reproducing layer is unfocused, an optical spot on the photo detector is unfocused. Hence, the reflected light from the non-reproducing layer forms a large optical spot as shown in FIG. 3. However, as shown in FIG. 3, the position of the optical spot on the photo detector 19 formed by the reflected light from the non-reproducing layer is varied depending on whether the reproducing layer is a layer L0 (a layer closer to the objective lens 16) or a layer L1 (a layer distant from the objective lens 16). More specifically, in the case where the non-reproducing layer is the layer L0, the reflected light from the layer L0 forms an optical spot indicated by a symbol RL (L0) in FIG. 3. Additionally, in the case where the non-reproducing layer is the layer L1, the reflected light from the layer L1 forms an optical spot indicated by a symbol RL (L1) in FIG. 3. When these optical spots are incident on the receiving regions of the photo detector 19, the S/N ratios of signals are degraded. Hence, the photo detector 19 is arranged at a position which avoids the optical spot from the non-reproducing layer (L0 or L1). In the case where the photo detector 19 includes a large number of receiving regions, each of the receiving regions avoids the optical spot from the non-reproducing layer. Accordingly, the space for arranging the receiving regions is limited, and it becomes difficult to arrange the receiving regions. Thus, it is desirable to reduce the number of the receiving regions. It should be noted that the center portion of the optical spot from the non-reproducing layer enters the receiving regions of the photo detector 19. Thus, it is desirable to increase the diffraction angle of the holographic diffraction element 14 so as to prevent the light of the center portion of the holographic diffraction element 14 (the portion indicated by a symbol Z in FIG. 2A) from entering the photo detector 19.

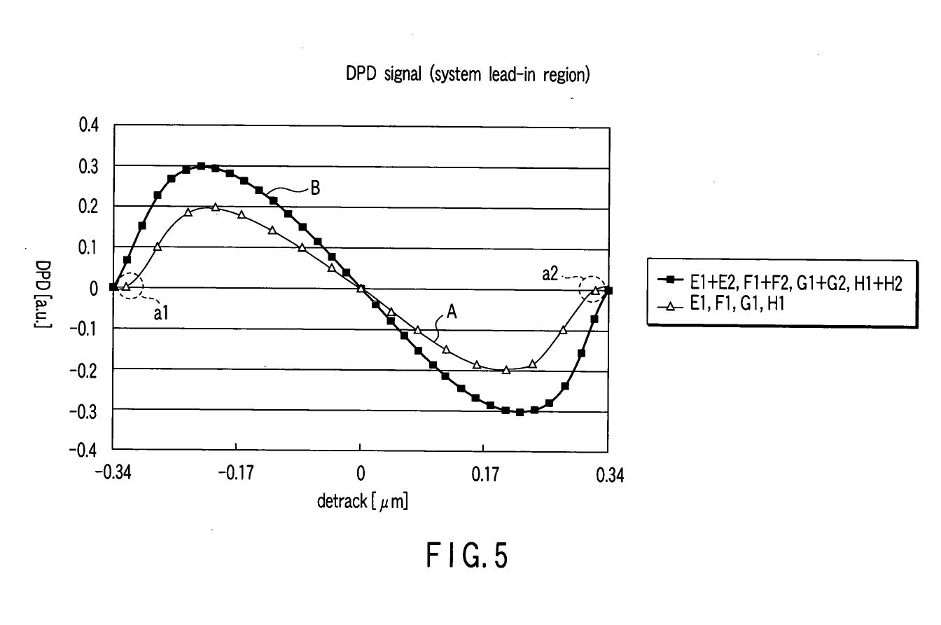

Referring to FIG. 4, a description is given of the dividing pattern for dividing a holographic diffraction element into a plurality of regions. FIG. 4 is a schematic diagram for explaining a dividing pattern of a holographic diffraction element according to one embodiment of the invention. In FIG. 4, the direction indicated by an arrow X represents a tangential direction of a track of an optical recording medium, and the direction indicated by an arrow Y represents a radial direction of the optical recording medium. It should be noted that FIG. 4 shows the portion indicated by the symbol S in FIG. 2A in an enlarged manner.

Here, it is assumed that the focus region includes a short size in the tangential direction X, and a long size in the radial direction Y. In this manner, it is possible to reduce variation in a signal caused by track crossing at the time of defocusing. The holographic diffraction element according to one embodiment of the invention can be divided into two kinds of regions: (1) the focus region and the compensation region; and (2) the tracking region. Accordingly, when the focus region includes the short size in the tangential direction X and a long size in the radial direction Y, the tracking region also includes the short size in the tangential direction X and the long size in the radial direction Y. Here, in the case where the focus region and the compensation region are close to the center of the aperture, the focus signal and the compensation signal include a lot of track cross components. Especially, in an optical disc having a narrow interval between grooves, the diffraction angle of diffracted light is small, and the region where the diffracted light and non-diffracted light overlap to each other becomes large. As a result, the focus signal includes a lot of track cross components.

Accordingly, in the holographic diffraction element (see FIG. 2A) according to one embodiment of the invention, the holographic diffraction element is divided into a plurality of regions such that the following condition is satisfied.

When the radius of the aperture is 1, L3>0.4 (Condition 1).

The track pitch in a system lead-in area of an HD DVD is 0.68 μm, irrespective of the kind of HD DVD (e.g., ROM, -R, -RW or RAM), and is different from the track pitch in a data area. Additionally, the DPD method is used as a tracking error detection method in the system lead-in area of an HD DVD. Here, when the center regions (E1, F1, G1 and H1 in FIG. 2A) are selected as regions for obtaining the tracking error signal according to the DPD method, it is difficult to achieve stable tracking.

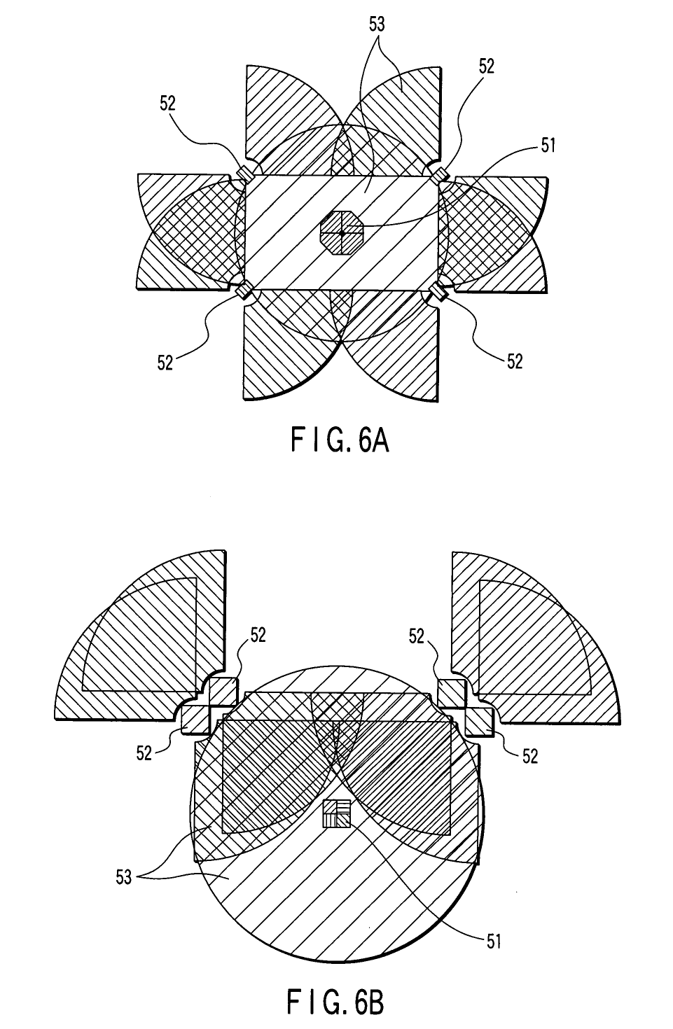

Here, referring to FIG. 5, a description is given of the DPD signal in the system lead-in area. FIG. 5 is a graph showing the signal intensity of the DPD signal in the system lead-in area. In FIG. 5, the horizontal axis represents detrack (unit: μm), and the vertical axis represents the signal intensity of the DPD signal (a.u.: arbitrary unit). A graph indicated by a symbol A represents the DPD signal obtained from the center regions (E1, F1, G1 and H1 in FIG. 2A) of the holographic diffraction element 14. A graph indicated by a symbol B represents the DPD signal obtained from end regions (E2, F2, G2 and H2 in FIG. 2A) in addition to the center regions (E1, F1, G1 and H1 in FIG. 2A) of the holographic diffraction element 14.

Referring to the graph A in FIG. 5, when detrack is −0.34 μm or 0.34 μm, broken portions (portions indicated by symbols a1 and a2 in FIG. 5) emerge at the time of track crossing. Thus, it is difficult to perform stable tracking. On the other hand, referring to the graph B in FIG. 5, the DPD signal without such broken portions is obtained by adding the components obtained from the end regions (E2, F2, G2 and H2 in FIG. 2A) to the center regions (E1, F1, G1 and H1 in FIG. 2A) of the holographic diffraction element 14. In order to secure the amount of light in the end regions (E2, F2, G2 and H2 in FIG. 2A) of the holographic diffraction element 14, the following condition is to be satisfied.
L1>0.1 (Condition 2)

Here, the radius of the aperture is 1, and thus the following condition is derived.
L2+L3<0.9 (Condition 3)

Additionally, considering the amount of light for focusing, the following condition is also to be satisfied.
L2<0.1

The following conditions are derived from the above-mentioned Conditions 1 through 3.
0.4<L3<0.8 (Condition 4)
L2>0.1 (Condition 5)

By dividing the holographic diffraction element into a plurality of regions such that the above-mentioned Conditions 4 and 5 are satisfied, it is possible to perform stable servo control.

Specific servo signals are obtained from signals (or currents or voltages) obtained from the photo detector 19 in the following manner.
Focus Error Signal=(A1+B2)−(A2+B1)
Push-Pull Signal=(E+F)−(G+H)
Compensation Signal=(A1+A2)−(B1+B2)
Compensation Push-Pull Signal=(E+F)−(G+H)−k{(A1+A2)−(B1+B2)} (k: appropriate number)
DPD Signal=Ph(E1+E2+G1+G2)−Ph(F1+F2+H1+H2) (Ph(x) means a phase of x)

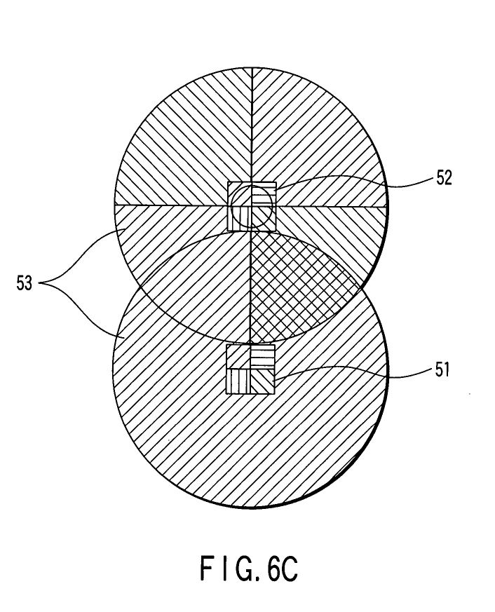

Next, referring to FIGS. 6A, 6B and 6C, a description is given of a region pattern of a photo detector.

FIG. 6A is a schematic diagram showing an arrangement patter of receiving regions of a photo detector. FIG. 6A shows four focus and compensation regions 51 (corresponding to A1, A2, B1 and B2 in FIG. 2B) and four tracking regions 52 (corresponding to E, F, G and H in FIG. 2B). More specifically, the four focus and compensation regions 51 are gathered at almost one position. The four tracking regions 52 are arranged at different positions so as to surround the focus and compensation regions 51. It should be noted that each of the receiving regions is arranged so as to avoid reception of reflected light 53 from the non-reproducing layer of the dual layer disc.

FIG. 6B is a schematic diagram showing another arrangement pattern of the receiving regions of the photo detector. FIG. 6B shows the four focus and compensation regions 51 (corresponding to A1, A2, B1 and B2 in FIG. 2B) and the four tracking regions 52 (corresponding to E, F, G and H in FIG. 2B). More specifically, the four focus and compensation regions 51 are gathered at almost one position. The four tracking regions 52 are divided into two groups, and each of the groups includes two tracking regions 52. The two groups of the tracking regions 52 are arranged at different positions on a circumference of the same circle whose center is coincides with the center of the focus and compensation regions 51. It should be noted that each of the receiving regions is arranged so as to avoid reception of the reflected light 53 from the non-reproducing layer.

FIG. 6C is a schematic diagram showing still another arrangement pattern of the receiving regions of the photo detector. FIG. 6C shows the four focus and compensation regions 51 (corresponding to A1, A2, B1 and B2 in FIG. 2B) and the four tracking regions 52 (corresponding to E, F, G and H in FIG. 2B). In the arrangement pattern shown in FIG. 6C, the four focus and compensation regions 51 are gathered at almost one position. Similarly, the four tracking regions 52 are arranged gathered at almost one position. Additionally, the center of the four focus and compensation regions 51 and the center of the four tracking regions 52 are arranged on a straight line. It should be noted that each of the receiving regions is arranged so as to avoid reception of the reflected light 53 from the non-reproducing layer.

As mentioned above, according to one embodiment of the invention, the diffraction element is divided into: (1) the focus and compensation regions; and (2) the tracking regions. That is, the focus regions and the tracking regions are separated. Accordingly, it is possible to select regions having less track cross components as the focus regions, and stable servo (focus) control can be performed. In addition, since the common regions are used as the focus regions and the compensation push-pull regions, it is possible to secure a large amount of light for the focus error signal and the compensation push-pull signal. Further, in the case where the double knife edge method is used as a focus error detection method, and the compensation push-pull method is used as a tracking error detection method, ten photodetectors (receiving elements) are generally used. However, in one embodiment of the invention, eight receiving elements, i.e., less number of receiving element are used. Thus, it becomes easier to arrange the receiving elements while avoiding stray light from the non-reproducing layer. Additionally, since it is possible to reduce influence of the stray light from the non-reproducing layer at the time of reproduction of a double-layer disc, the S/N ratio of a reproduction signal is improved.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A holographic diffraction element divided into regions which diffract reflected light from an optical recording medium to photodetectors,
wherein diffracted light for detecting a focus error signal and a compensation signal for a tracking error signal is obtained from one or more common regions of the regions.

2. The holographic diffraction element according to claim 1, wherein the focus error signal is a focus error signal according to a double knife edge method, and the compensation signal is a compensation signal according to a compensation push-pull method.

3. The holographic diffraction element according to claim 2, wherein the plurality of regions are formed by dividing the holographic diffraction element into two regions with a dividing line parallel to a tangential direction of the optical recording medium, and by dividing each of the two regions into plural regions with dividing lines parallel to a radial direction of the optical recording medium.

4. The holographic diffraction element according to claim 3, wherein, the compensation signal is based on a difference between an amount of light obtained from regions at an inner peripheral portion and an amount of light obtained from regions at an outer peripheral portion.

5. The holographic diffraction element according to claim 4, wherein a differential phase detection signal is obtained based on signals from end regions in the tangential direction.

6. The holographic diffraction element according to claim 3, wherein a differential phase detection signal is obtained based on signals from end regions in the tangential direction.

7. An optical pickup apparatus, comprising:
a light source configured to emit an optical beam;
an objective lens configured to focus the optical beam from the light source onto an optical recording medium, and receive the optical beam reflected by the optical recording medium;
a servo control unit configured to perform focus control and tracking control of the objective lens;
a holographic diffraction element configured to be divided into regions which diffract the optical beam reflected from the optical recording medium, one or more of common regions of the regions being used to obtain diffracted light for detecting a focus error signal and a compensation signal for a tracking error signal; and
photodetectors which receive the diffracted light obtained from the holographic diffraction element.

8. The optical pickup apparatus according to claim 7, wherein the focus error signal is a focus error signal according to a double knife edge method, and the compensation signal is a compensation signal according to a compensation push-pull method.

9. The optical pickup apparatus according to claim 8, wherein the plurality of regions are formed by dividing the holographic diffraction element into two regions with a dividing line parallel to a tangential direction of the optical recording medium, and by dividing each of the two regions into plural regions with dividing lines parallel to a radial direction of the optical recording medium.

10. The optical pickup apparatus according to claim 9, wherein, the compensation signal is based on a difference between an amount of light obtained from regions at an inner peripheral portion and an amount of light obtained from regions at an outer peripheral portion.

11. The optical pickup apparatus according to claim 10, wherein a differential phase detection signal is obtained based on signals from end regions in the tangential direction.

12. The optical pickup apparatus according to claim 9, wherein a differential phase detection signal is obtained based on signals from end regions in the tangential direction.
